(19) United States
(12) Patent Application Publication
(10) Pub. No.: US 2024/0060863 A1
(43) Pub. Date: Feb. 22, 2024

(54) FREEZING AND JACKETING GAS-PHASE BIOMOLECULES WITH AMORPHOUS ICE FOR ELECTRON MICROSCOPY

(71) Applicant: Wisconsin Alumni Research Foundation, Madison, WI (US)

(72) Inventors: Michael WESTPHALL, Fitchburg, WI (US); Joshua COON, Middleton, WI (US)

(73) Assignee: Wisconsin Alumni Research Foundation, Madison, WI (US)

(21) Appl. No.: 18/261,267

(22) PCT Filed: Jan. 13, 2022
(86) PCT No.: PCT/US2022/012277

§ 371 Date: Jul. 13, 2023

Related U.S. Application Data
(60) Provisional application No. 63/136,850, filed on Jan. 13, 2021.

(51) Int. Cl. G01N 1/42; G01N 1/28

(52) U.S. Cl. CPC G01N 1/42; G01N 1/2813

(57) ABSTRACT

The present invention provides an improved technique for cryogenically fixing biological samples in amorphous ice for analysis by cryo-electron microscopy (cryo-EM). Analyte particles are cooled to very low temperatures prior to depositing the particles onto a cooled substrate surface, such as a transmission electron microscope (TEM) grid. This approach “locks” in the particle structure prior to deposition. Either concurrently with or after deposition, the analyte particles are further contacted with a vapor stream of atoms or molecules at cryogenic or near cryogenic temperatures. As a result, a thin layer of an amorphous solid is formed around each particle without significant conformational changes in the particle structure, thereby forming an improved sample for EM analysis.

### CROSS-REFERENCE TO RELATED APPLICATIONS

This application claims the benefit of priority to U.S. Provisional Patent Application No. 63/136,850, filed Jan. 13, 2021, which is specifically incorporated by reference to the extent not inconsistent herewith.

### STATEMENT REGARDING FEDERALLY SPONSORED RESEARCH

This invention was made with government support under GM118110 awarded by the National Institutes of Health. The government has certain rights in the invention.

### BACKGROUND OF THE INVENTION

Mass spectrometry (MS) technologies are currently used to analyze, en masse, protein abundance, modification state, interaction partners, and even biochemical pathways in which proteins function. Native MS gently ionizes protein complexes using electrospray under conditions that preserve protein structure. Extremely accurate mass measurement of these mega-Dalton protein complexes allows for calculation of sub-unit stoichiometry and even identification of non-covalently bound small molecules.

Further tools for gaining structural information using MS technologies include ion mobility, chemical cross-linking, covalent labeling, and dissociation technologies such as surface-induced dissociation (SID). This collection of MS techniques is increasingly recognized as both critical for complete structural characterization and complementary to the emergent field of cryo-electron microscopy (cryo-EM). Capable of imaging protein and other biomolecule particles in the native state, single-particle cryo-EM allows proteins and other biomolecules to be examined in three-dimensional (3D) images that reveal their orientations in high detail. This technique has accelerated the rate and ease with protein structure is determined—a feat that earned its early pioneers the 2017 Nobel Prize in Chemistry.

Thus, single particle cryo-EM is a powerful tool for structural studies of eukaryotic cells, proteins (>150 kDa), and macromolecular complexes (e.g., liposomes, organelles, and viruses) (Stark et al., Microscopy, 2016, 65(1):23-34)). However, for cryoEM imaging to be successful, the purified sample must be fixed in amorphous (i.e., vitreous) solid, such as amorphous ice. Typically, purified biomolecule complexes are spotted onto a transmission electron microscope (TEM) grid in an aqueous solution, the excess solution is blotted off (also removing approximately 99% of the sample), and the entire grid is plunged into a liquid cryogen to vitrify the remaining solution/sample. The idea is to vitrify the biolmolecule complex in a layer of ice just a few nanometers thicker than the complex itself. Unlike crystalline ice, this coat of amorphous ice is transparent to the electron beams used in EM, protects the particles from radiation and, when thin as possible, can enable increased contrast for a sharper structural image and permit imaging of smaller molecules/particles.

Challenges in sample vitrification are well known to cryo-EM experts. Obtaining a high-resolution structure requires that all particles be of the same structural conformation and be randomly oriented within the ice. However, in the plunge freezing method, unchanged since its introduction over 40 years ago, the particles are prone to move toward, and remain in, the air-water interface before freezing. This phenomenon both imparts a non-random orientation and causes structural deformations (see FIG. 1, panel A).

While an array of methods and devices have been developed to eliminate some of the problems associated with plunge freezing, all of them are limited by the need for rapid plunging into a cryogen. Furthermore, structural deformations often arise from the absorption of the particles to the TEM grid itself. Additionally, given that most of the sample is blotted away, individual holes within the grid are often sparsely populated. These issues, combined with non-uniform ice thickness, necessitate long data acquisition times. Operators often must search the TEM grid for thousands of particles in random orientations in ice of the appropriate thickness.

The ideal cryo-EM sample would have a high density of particles situated in random orientations within the same focal plane. Preferably, the particles would be covered with only a few nanometers of the amorphous solid and be separated from each other by even less amounts of the amorphous solid (see FIG. 1, panel B).

### SUMMARY OF THE INVENTION

The present invention provides improved techniques for cryogenically fixing analyte particles, such as biological samples, in amorphous ice and other frozen amorphous solids, particularly for analysis by cryo-electron microscopy (cryo-EM). Current conventional means for vitrifying samples introduce artifacts that decrease the structural resolution obtainable with cryo-EM. The present methods reduce or eliminate these artifacts, thereby increasing image resolution, decreasing image acquisition time, allowing for many orders of magnitude increase in sensitivity, and brings the advantages of afforded by mass spectrometry to cryo-EM sample preparation. A previous method developed by the present inventors for generating samples for cryo-EM was described in WO 2019/010436. The present invention is an alternative or complementary method that may provide additional advantages to the methods described in WO 2019/010436.

In one embodiment of the present invention, analyte particles are cooled to very low temperatures prior to depositing the particles onto a cooled substrate surface, such as a transmission electron microscope (TEM) grid. This approach “locks” in the particle structure prior to deposition on the cryogenically cooled TEM grid. The analyte particles are further contacted with a vapor stream of atoms or molecules at cryogenic or near cryogenic temperatures (i.e., a temperature of −90° C. or less), preferably under a vacuum. As a result, a thin layer of an amorphous solid is formed around each particle without significant conformational changes in the particle structure, thereby forming an improved sample for EM analysis.

Amorphous solids, or non-crystalline solids, refer to solids that lack the long-range molecular order characteristic of crystals. For example, ice formed using the methods and systems described herein is preferably amorphous ice (also referred to herein as vitreous ice). Common H₂O ice is a hexagonal crystalline material where the molecules are regularly arranged in a hexagonal lattice. In contrast, amorphous ice lacks the regularly ordered molecular arrangement. Amorphous ice and the other amorphous solids available with the present invention are generally produced either by rapid cooling of the liquid phase (so the molecules do not have enough time to form a crystal lattice) or by compressing ordinary ice (or ordinary solid forms) at very low temperatures.

Preferably, each analyte particle deposited on the substrate is coated by a thin layer of the amorphous solid without multiple analyte particles being encased in the same continuous layer of the amorphous solid (see FIG. 1, panel B). The layer of the amorphous solid surrounding the analyte particles may be formed by contacting the analyte particles with the atoms or molecules from the vapor stream after the analyte particles have been deposited on the substrate surface. Alternatively, the substrate surface is contacted with the cooled analyte particles and vapor stream beam concurrently. Preferably, the amorphous solid layer surrounding each particle formed by the methods of the present invention has an average thickness of 5 microns or less, 2 microns or less, 1 micron or less, 500 nm or less, 150 nm or less, or 100 nm or less.

As used in embodiments described herein, one or more steps used in the present invention, independently from one another, are performed at temperatures of −90° C. or less, preferably −100° C. or less, −130° C. or less, −150° C. or less, −175° C. or less or 185° C. or less.

As used in embodiments described herein, “under a vacuum” refers to a pressure of 10⁻⁴ Torr or less, a pressure 10⁻⁵ Torr or less, or a pressure 10⁻⁶ Torr or less. In certain embodiments, the atoms or molecules of the vapor stream contact the substrate surface and/or the analyte particles at a pressure equal to or less than 10⁻⁴ Torr, 10⁻⁵ Torr, or 10⁻⁶ Torr. In certain embodiments, 10⁻⁴ Torr is likely near the high pressure limit; however, higher pressure may be permissible if the environment is water free.

In an embodiment, the present invention provides a method for preparing a sample for cryo-electron microscopy (cryo-EM) comprising the steps of: a) generating and cooling charged or uncharged analyte particles to a temperature of −90° C. or less; b) contacting a substrate surface with the cooled analyte particles, wherein the substrate surface is at a temperature of −90° C. or less, thereby forming a layer of analyte particles on the substrate surface; c) forming a vapor stream of atoms or molecules; and d) contacting the substrate surface with the vapor stream while under vacuum at a temperature of −90° C. or less, thereby forming an amorphous solid layer on the substrate surface, wherein the analyte particles are embedded on or within the amorphous solid layer. In an embodiment, the substrate surface is contacted with the cooled analyte particles and vapor stream concurrently, or, alternatively, the substrate surface is contacted with the cooled analyte particles prior to being contacted with the vapor stream.

In a further embodiment, the analyte particles in step a) are cooled to a temperature of −100° C. or less, −130° C. or less, −150° C. or less, −175° C. or less or −185° C. or less. Similarly, the substrate surface temperature in step b) and the temperature at which the substrate surface is contacted with the vapor stream in step d) are −100° C. or less, −130° C. or less, −150° C. or less,

−175° C. or less or −185° C. or less. The temperatures in steps a), b) and d) are independent from one another. For example, the analyte particles in step a) and the substrate surface in step b) may be cooled to a temperature of −90° C. or less while the temperature in step d) is at a temperature of −130° C. or less. Preferably, the atoms or molecules of the vapor stream contact the substrate surface and/or the analyte particles at a pressure equal to or less than 10⁻⁴ Torr, 10⁻⁵ Torr, or 10⁻⁶ Torr.

In an embodiment, the present invention provides a method for preparing for cryo-electron microscopy (cryo-EM) comprising the steps of: a) mixing a portion of charged or uncharged analyte particles in a cooling chamber with a vapor comprising atoms or molecules at a temperature of −90° C. or less; b) forming an amorphous solid layer of the atoms or molecules from the vapor around each of said analyte particles, thereby forming trapped analyte particles; c) contacting a substrate surface with the analyte particles trapped within the amorphous solid layer while under vacuum at a temperature of −90° C. or less, thereby forming a layer of analyte particles on the substrate surface. Optionally, the method further comprises mixing helium with the portion of analyte particles in the cooling chamber with the vapor comprising atoms or molecules. In a further embodiment, the analyte particles and vapor in step a) are cooled to a temperature of −100° C. or less, −130° C. or less, −150° C. or less, −175° C. or less or −185° C. or less. In a further embodiment, the substrate surface in step c) is at a temperature of −100° C. or less, −130° C. or less, −150° C. or less, −175° C. or less or −185° C. or less. Preferably, the step of contacting the substrate surface with the trapped analyte particles is carried out at a pressure equal to or less than 10⁻⁴ Torr, 10⁻⁵ Torr, or 10⁻⁶ Torr.

Optionally, the amount of atoms or molecules deposited on the analyte particles to form the amorphous solid layer are determined and monitored, such as by a mass analyzer. This allows the thickness of the amorphous solid layer to be controlled by adjusting the amount of atoms or molecules contacting the analyte particles. For example, in an embodiment, the present methods further comprise adjusting the thickness of the amorphous solid layer around each of the analyte particles by adjusting the concentration of the atoms or molecules in the vapor surrounding the analyte particles. In an embodiment, the thickness of the amorphous solid layer around each of the analyte particles is adjusted by adjusting the mixing time between the analyte particles and the vapor.

Preferably the vapor stream is controlled, the concentration of atoms or molecules in the vapor stream is adjusted, or the deposited amorphous solid layer is otherwise refined, so that the amorphous solid layer encasing the analyte particles has a thickness of 5 microns or less, 2 microns or less, 1 micron or less, 500 nm or less, 150 nm or less, or 100 nm or less. Preferably, the amorphous solid layer around each analyte particle has a uniform thickness which does not vary by more than 5%. Preferably, the layer of the amorphous solid has an extent of crystallinity less than or equal to 1%. Preferably, the layer of the amorphous solid has a purity of at least 85%, 90%, 95%, or 99%.

The vapor stream used in the present invention can comprise any molecules or atoms able to form amorphous solids where exposed to extremely low temperatures and pressures. Such molecules and atoms include, but are not limited to, cyclohexanol, methanol, ethanol, isopentane, water, O₂, Si, SiO₂, S, C, Ge, Fe, Co, Bi and mixtures thereof. Optionally, the vapor stream comprises charged molecules. In an embodiment, the vapor stream comprises water molecules and the amorphous solid is amorphous ice.

In an embodiment, the vapor stream is generated using a Knudsen-type effusion cell, a molecular beam doser, or a co-effusion of a matrix with analyte into the system. Optionally, the vapor stream is characterized by an intensity selected from the range of 4.8E9 to 2.8E11 molecules per μm² per second and/or a spot size selected from the range of 800 μm² to 3.8E7 μm². In an embodiment, the vapor stream comprises a flux of molecules having a uniformity within 98% over an area of 7 mm². In certain embodiments, the vapor stream is a molecular beam. Molecular beams are streams of molecules traveling in the same or similar direction and can be produced by allowing a gas at higher pressure to expand through a small orifice into a chamber at lower pressure to form the beam. Preferably, the incident trajectory of the particles of the vapor stream contacting the substrate surface is within 1 degree of normal to the substrate surface.

In a further embodiment, the vapor stream (or molecular water beam) is reflected off of one or more reflecting surfaces prior to contacting the substrate surfaced. This ensures that the atoms or molecules are broken up and have a randomized orientation before contacting the substrate.

The analyte particles can be charged or uncharged particles depending on the deposition method used to deposit the particles. Preferably, the analyte particles and the molecules making the amorphous solid layer are substantially randomly orientated when deposited on the substrate, such as on a membrane, film, or TEM grid. In embodiments, the analyte particles are deposited on the substrate surface using an analyte beam, which is preferably an ion beam, molecular beam, or particle beam. In embodiments, the analyte particles are ions formed using techniques including, but not limited to, electrospray ionization and laser desorption, such as matrix-assisted laser desorption/ionization (MALDI). Preferably, the analyte particles are ionized under native electrospray conditions so as not to perturb structural conformation of the particles. In a further embodiment, the analyte ions are formed using a mass spectrometer which optionally isolates or purifies the analyte ions. Alternatively, the particle beam is a molecular beam. In a further embodiment, the molecular beam is produced by creating an aerosol of an analyte particle containing solution and introducing the aerosol into the vacuum system.

In embodiments where the analyte particles are deposited using an analyte beam, the analyte beam is characterized by an intensity selected from the range of 0.025 to 25 particles per 1 μm² per second, 0.05 to 10 particles per 1 μm² per second, or 0.1 to 5 particles per 1 μm² per second. In certain embodiments, the analyte beam is characterized by a spot size selected from the range of 800 μm² to 3.8E7 μm².

Certain aspects of the invention further include the use of mass spectrometry to purify analyte particles, including but not limited to proteins, protein complexes, and cells, in the gas-phase for subsequent vitrification. Samples prepared in this way can be extracted from the mass spectrometer using a cryo-transfer sample holder and placed directly into an EM for imaging. One implementation of this method utilizes a modified mass spectrometer that allows for gas-phase purification of analyte ions. The ions will be passed over a cooled sample probe where they are deposited onto an EM sample holder and vitrified.

In an embodiment, the analyte particles are purified or isolated, such as by a mass spectrometer device, before being deposited onto the amorphous solid. Preferably, the analyte beam is characterized by a purity of at least 50%, 60%, 75%, 85%, 90%, 95%, or 99%. For analyte particles, such as proteins, which may have significant conformational structures, it is desirable that the analyte beam is characterized by a conformation purity of at least 50%, 60%, 75%, 85%, 90%, 95% or 99%. For example, it may be desirable to analyze the structure of a particular protein as expressed in a cell. Accordingly, it is necessary to provide an EM sample where all or most of the protein analyte molecules retain the same conformational structure.

Analyte particles useful with the present invention include, but are not limited to, protein molecules, peptides, glycans, metabolites, drugs, and complexes thereof, multi-protein complexes, protein/nucleic acid complexes, nucleic acid molecules, virus particles, micro-organisms, sub-cellular components (e.g., mitochondria, nucleus, Golgi, etc.), and whole cells. In some embodiments, the analyte particles are molecular entities, single molecules, or multiple molecules complexed together through non-covalent interactions (such as hydrogen bonds or ionic bonds). In embodiments, the analyte particles have a molecular mass exceeding 500, 1,000 Daltons, 10,000 Daltons, 50,000 Daltons, 100,000 Daltons, or 150,000 Daltons.

In an embodiment, the analyte particles are ions and the analyte source is able to generate a controllable ion beam containing charged analyte ions (such as electrospray ion deposition) and direct the ion beam to contact the receiving surface of a cryo-EM probe. In a further embodiment, the system further comprises a modified mass spectrometer that can provide purified ions to the analyte source. In another embodiment, the system comprises an electron microscope where the cryo-EM probe is directly transferred from the deposition portion of the instrument to the microscope portion of the instrument for analysis.

Optionally, the substrate described in the embodiments provided herein is an electron microscopy (EM) grid as known in the art. The EM grid may comprise a metal, including but not limited to copper, rhodium, nickel, molybdenum, titanium, stainless steel, aluminum, gold, or combinations thereof as known in the art. Additionally, the EM grid may comprise a continuous film or membrane which is positioned across the top or bottom surface of the grid, or within the holes of the grid, so as to provide a solid support for the formation of the amorphous solid. Preferably, the EM grid is covered by a thin film or membrane which includes, but is not limited to, films and membranes comprising graphene, graphene oxide, silicon oxide, silicon nitride, carbon, and combinations thereof. With a grid that does not contain a film or membrane, the molecular beam intended to form the amorphous solid may pass through at least a portion of the holes in the grid without producing a suitable layer. The film or membrane should be thin enough so as to not scatter electrons. Preferably, the film or membrane has an approximate thickness or 15 nm or less, 10 nm or less, 5 nm or less, 2 nm or less, or 1 nm or less. In an embodiment, the substrate is an EM grid comprising a graphene or graphene oxide monolayer film or membrane positioned across the surface of the grid.

### BRIEF DESCRIPTION OF THE DRAWINGS

FIG. 1 shows typical and ideal samples for single-particle cryo-EM. Plunge freezing produces samples with a variety of issues that limit the effectiveness of single-particle cryo-EM (panel A). In particular, particles tend to be arranged in similar orientations and preferentially locate to the air-surface interface. The resulting ice thickness is also highly variable, requiring long acquisition times as multiple grids must be searched for useful particles. In an ideal single-particle sample, the particles are in the same focal plane at regular intervals in random orientations (panel B). The ice coat is consistently only a few nms thick and is largely absent between particles to boost contrast.

FIG. 2 illustrates a mass spectrometer in an embodiment adapted to purify and land native protein complexes onto cryogenically cooled TEM grids and coat with amorphous ice. Protein complexes are gently ionized and transferred to the vacuum chamber of the MS (panel A). In an example, mass is determined using an Orbitrap mass analyzer, revealing a sample containing a GroEL monomer, complete complex (GroEL₁₄), and a sub-population of incomplete complexes (GroEL₁₃) (panel B). The quadrupole mass filter is then used to purify the intact complex (GroEL₁₄) from the others and direct these particles into an added chamber (panel C). This chamber directs the particles land onto a TEM grid coated with a monolayer of graphene (panel D).

FIG. 3 shows an example of a retractable ion guide, full view (top) and cross-sectional view (bottom). Components of the retractable ion guide include an RF octopole ion guide segment connecting to mass spectrometer (A), a vacuum gate valve (B), molecular beam dosers (C), a grid ion guide which is an RF octopole ion guide connecting to cooling box (D), a single element ion lens (E), a cooling box (F), and a linear slide (G).

FIG. 4 illustrates the deposition of particles on a surface of a TEM grid using a conventional plunge freezing method (panel A), forming amorphous ice on deposited particles using a molecular beam or ion beam (panel B), and a method in an embodiment of the present invention where amorphous ice is formed around particles prior to the particles being deposited on the surface (panel C).

### DETAILED DESCRIPTION OF THE INVENTION

Overview

Cryo-electron microscopy (cryo-EM) provides 3D structural information on non-crystalline specimens and is an emergent powerful tool for the structural studies of proteins and macromolecular assemblies, including protein complexes and viruses (Stark and Chari, “Sample preparation of biological macromolecular assemblies for the determination of high-resolution structures by cryo-electron microscopy,” Microscopy, 2016, 65(1): 23-34). With the development of a new class of electron detectors and advances in software image reconstruction, cryo-EM has approached atomic level resolution, enabling many new biological discoveries and driving further biological inquiry. However, the image resolution achievable with transmission electron microscopes is not easily obtainable when analyzing biological samples, and sample preparation is a significant bottleneck.

Imaging by cryo-EM requires that a purified sample be vitrified, as encasing the sample in amorphous (vitreous) ice helps protects the sample from radiation damage from the electron microscope. But current conventional protocols, which generally involve plunge-freezing to embed sample particles in a layer of amorphous ice, is challenged by problems with preferred particle orientation and deformation.

The present invention describes methods for trapping gas-phase particles, such as generated by electrospray ionization and delivered from a conventional mass spectrometer instrument, at cryogenic temperatures causing the particles to freeze, thus locking in the structure of the particles prior to deposition on a cryogenically cooled TEM grid. Once deposited, the cryogenic particles can be covered with thin films of amorphous ice. Alternatively, the cooled particles are jacketed with thin films of amorphous ice while confined in the cryogenic ion trap. The jacketed particles are then be deposited onto a cryo-cooled TEM grid within a vacuum system and later be directly imaged by cryoEM.

### Examples

In the present invention, techniques commonly associated with mass spectrometry (MS) are utilized for gas phase cryoEM sample preparation. Briefly, proteins and protein complexes are purified in the gas-phase for subsequent in vacuo vitrification. Samples prepared in this way can be extracted from the mass spectrometer using a cryo-transfer sample holder and placed directly into an EM for imaging.

In an initial embodiment, the integration of MS and cryo-EM sample preparation allows particle deposition on a transmission EM (TEM) grid and vitreous ice formation concomitantly (first demonstrated on a QE-UHMR mass spectrometer). This technique is referred to as biomolecular vapor deposition (BVD). The original BVD (see WO 2019/010436) was limited to coating a layer of biomolecules with a thin layer of amorphous ice after deposition. While an improvement over existing techniques, it was recognized that the initial version of BVD may suffer from some unwanted background noise and be limited to certain biomolecules. Recognizing these limitations, the present invention was developed to further improve resolution and to expand the types of molecules that could be prepared as suitable cryo-EM samples.

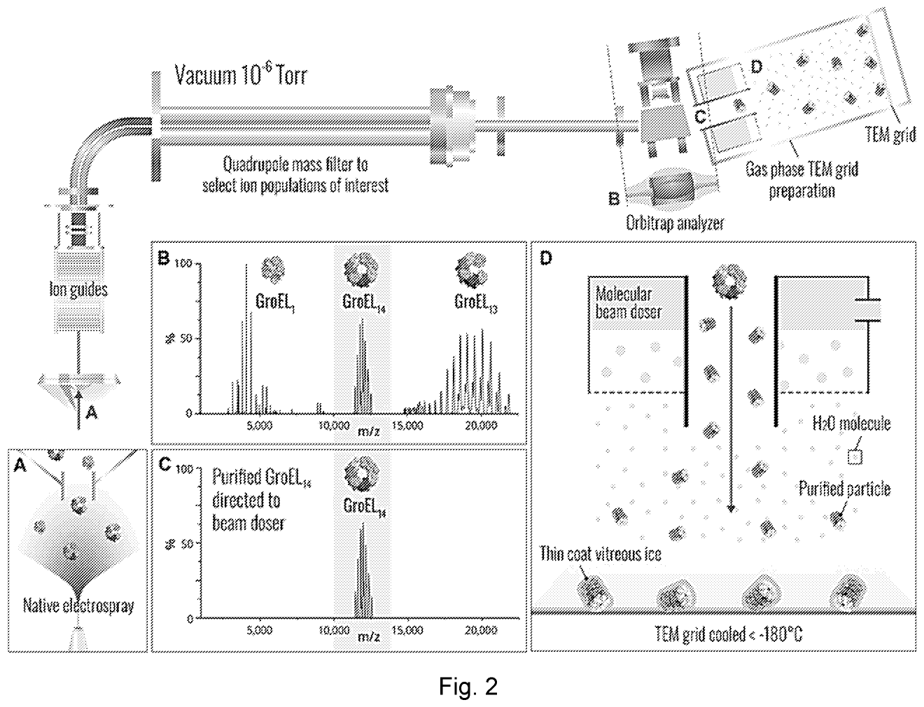

The concept and system of an exemplary embodiment of the present invention is depicted in FIG. 2. Protein complexes are gently ionized and transferred to the vacuum chamber of the MS device (FIG. 2, panel A). Mass is determined using an Orbitrap mass analyzer (FIG. 2, panel B), and the quadrupole mass filter is then used to purify the intact complex and direct these particles into an added chamber (FIG. 2, panel C).

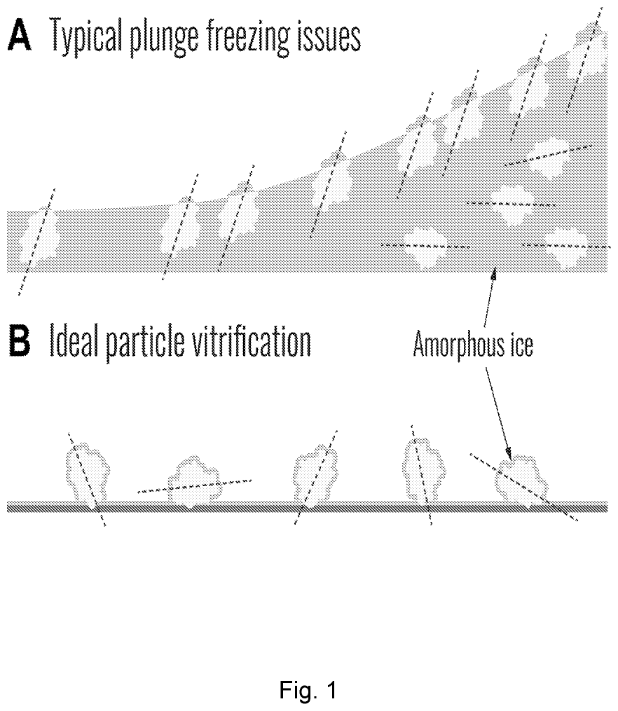

BVD requires a cryogenically cooled surface to support the TEM grid and a molecular beam doser that does not interfere with the path of the biomolecular ions. A special enclosed multipole-ion guide has been developed for this purpose. This guide transports the ions from the mass spectrometer C-trap to a separate vacuum chamber containing the cooled surface. Within the multipole enclosure are multiple small dosers aimed between the gaps of the ion guide rods and toward the enclosure's exit lens (FIG. 2, panel D). This design enables the MS-generated ions and water molecules to simultaneously exit the ion guide and impinge on a TEM grid, which will have been cooled to −175° C. With this device on can create ideally vitrified cryoEM samples as depicted in FIG. 1, panel B.

Gas-Phase Freezing and Amorphous Ice Jacketing.

The above concept deposits ambient temperature biomolecules onto a cryogenically cooled TEM grid and then further coats the particles with amorphous ice. However, in certain circumstances it could be advantageous to pre-cool the biomolecules prior to deposition onto the TEM grid. Accordingly, a cryogenic trapping multipole has been designed capable of cooling the gas-phase biomolecules to extremely low temperatures prior to their deposition.

Specifically, gas-phase biomolecule freezing prior to surface deposition may be especially useful for fragile or flexible molecules, allowing the molecules to retain their condensed phase shape by removing as much of their energy as possible before they contact the grid. A common practice in the field of gas-phase IR spectroscopy, freezing biomolecules in the gas-phase can be accomplished through the use of supersonic beams, decelerated beams, cooled or slowed buffer gases, or cryogenically cooled ion traps, amongst other methods (see Rijus and Oomens, “Gas-phase ir spectroscopy and structure of biological molecules,” Topics in current chemistry, 2015, Vol. 364; and Wall et al., “Preparation of cold molecules for high-precision measurements,” Journal of Physics B-Atomic Molecular and Optical Physics, 2016. 49(24)). Boyarkin et al. have further demonstrated the utility of a cryogenically cooled octopole ion trap to remove energy from biomolecules (“Cryogenically cooled octopole ion trap for spectroscopy of biomolecular ions,” Review of Scientific Instruments, 2014, 85, 033105).

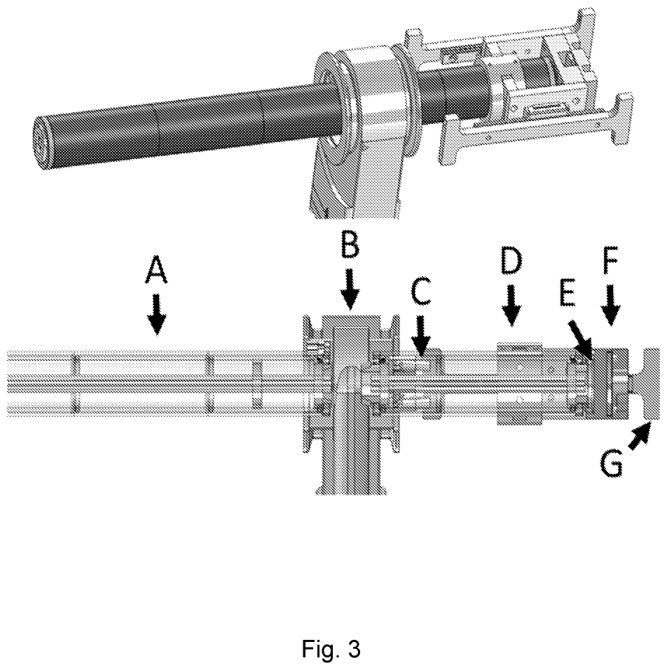

For this embodiment, the octopole (FIG. 3, item D) is modified by replacing the outer housing, which is currently aluminum, with oxygen-free copper in thermal contact with the cooling box (FIG. 3, item F). The outer housing will then reach the same temperature as the cooling block, −175° C. or less, using either liquid nitrogen or to liquid helium for cooling. In place of PEEK to support the electrodes of the octopole, a sapphire spacer is employed. Sapphire has excellent heat conductivity while at the same time exhibiting poor electrical conductivity, making it a highly effective electrical insulator and transporter of heat.

Thus, in this embodiment the rods of the octopole are cooled by the outer housing while appropriate electrical signals can still be applied to each octopole rod. In addition to the exit lens (FIG. 3, item E) an entrance lens will be added to the grid octopole. Both lenses are supported by sapphire and thus cooled by the outer housing. This arrangement forms an enclosed region with cryogenically cooled walls to which helium can be added. Helium is ideal as it will not stick to the cold walls but will quickly deposit any additional energy it may have there. Hence it will continually interact with the electrically trapped biomolecule ions, carrying away any internal energy the biomolecules may have. Additionally, if the biomolecules are not allowed to fully desolvate, a significant amount of water or solvent adducts may be present, circumventing the need to add additional water for amorphous ice formation.

Jacketing with Amorphous Ice.

In one embodiment cryogenically cooled, trapped biomolecules are directly deposited onto a cryogenically cooled TEM grid where BVD is used to provide a coating of amorphous ice. In another embodiment, water molecules from the dosers will also be released in the cryogenically cooled trapping region. With their energy also removed by the helium atoms, these extremely cold water molecules will randomly attach to the biomolecules, forming a thin layer of amorphous ice around each. The thickness of this coating can be precisely controlled by adjusting either the concentration of water molecules in the trap or the duration of time the biomolecules spent in the trapping volume prior removal and deposition onto the cryogenically cooled TEM grid. From here the grid can be removed and imaged by cryo-EM.

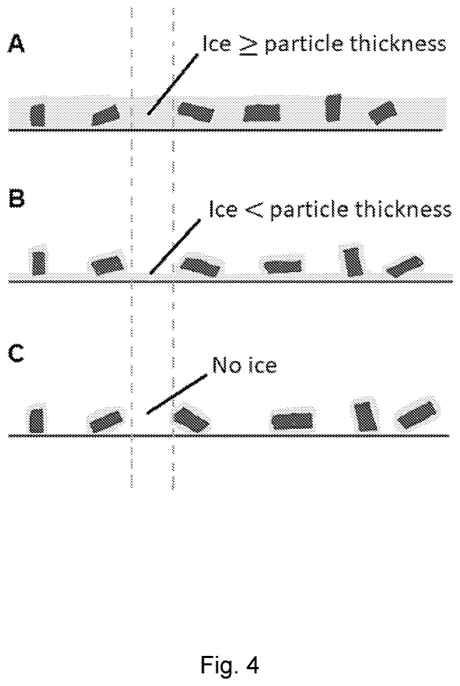

The result would be a grid appears as depicted in FIG. 1, panel B, except that no thin film of ice would be present between particles. This ice jacketing approach has many advantages including, but not limited to: (1) fixing the analyte structure while still in a mass spectrometer or other analyzing device, (2) providing a precise coat of amorphous ice to maximize signal while still offering protection from radiation damage, (3) providing a protective ice barrier to limit any possible damage during deposition onto the TEM grid surface, (4) eliminating TEM grid surface interactions once deposited, and (5) reducing the presence of ice in between particles. FIG. 4 illustrates various approaches for cryoEM sample preparation. FIG. 4, panel A, illustrates the surface of a conventionally prepared TEM grid. Due to the conventional plunge freezing method, the amorphous ice layer is at least as thick as the particles, and is often thicker than the particles. This further results in a thick layer of ice being deposited between all the particles (see dashed line inset). This continuous amorphous ice layer increases the background signals and makes it difficult to distinguish particles from background ice. The result is that smaller particles (i.e., <100,000 Da) are difficult to image by cryoEM.

FIG. 4, panel B, displays particles on a TEM grid surface using the previously described technique of forming amorphous ice on deposited particles using a molecular beam of water, or potentially an ion beam. Here a controlled layer of amorphous ice is blanketed over the entire surface, covering both the particles and the spaces between particles (see dashed line inset). The result of this approach is that the amount of added ice can be controlled and is easily made less than the thickness of the particle. Still some ice will occupy the space between the particles—reducing but not entirely eliminating the signal noise caused by the ice background. FIG. 4, panel C, illustrates the resulting surface following the jacketing methods disclosed in this example. Because the ice is jacketed onto the particles upstream of the deposition, the ice jacketed particles are simply deposited onto the grid surface. In this fashion, no ice is present between the particles. The result is a dramatic reduction of background ice and improvement in the ability to obtain cryoEM data on small particles (i.e., those <100,000 Da).

Thus, the present example provides a cryogenic trapping multipole device capable of cooling gas-phase biomolecules to extremely low temperatures prior to the deposition of the biomolecules onto a TEM grid. This device and method could be particularly useful for fragile or flexible biomolecules since removing as much of the biomolecule energy as possible before contact with the grid allows the biomolecules to retain their condensed phase shape.

In a first mode of operation, the cryogenically cooled, trapped biomolecules are directly deposited onto the TEM grid where BVD is used to provide a layer of amorphous ice over the deposited biomolecule particles. In an alternative mode of operation, water molecules from the dosers are released in the cryogenically cooled trapping region concurrent with the biomolecules. With their energy also removed by the helium atoms, these extremely cold water molecules will randomly attach to the biomolecules, forming a thin layer of amorphous ice around each biomolecule.

The thickness of the amorphous ice coating can be precisely controlled by adjusting either the concentration of water molecules in the trap or the duration of time the biomolecules spend in the trapping volume prior to removal and deposition onto the cryogenically cooled TEM grid. From here the grid can be removed and imaged by cryo-EM. This alternative mode of operation is particularly advantageous since it eliminates much of the ice between particles. Removing ice between the deposited particles should provide a significant increase in contrast upon TEM imaging and will potentially provide the highest quality resolution images ever recorded.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

1. A method for preparing a sample for cryo-electron microscopy (cryo-EM) comprising the steps of:
a) mixing a portion of charged or uncharged analyte particles in a cooling chamber with a vapor comprising atoms or molecules at a temperature of −90° C. or less;
b) forming an amorphous solid layer of the atoms or molecules from the vapor around each of said analyte particles, thereby forming trapped analyte particles;
c) contacting a substrate surface with the analyte particles trapped within the amorphous solid layer while under vacuum at a temperature of −90° C. or less, thereby forming a layer of analyte particles on the substrate surface.

2. The method of claim 1 further comprising mixing helium with the portion of analyte particles in the cooling chamber with the vapor comprising atoms or molecules.

3. The method of claim 1 wherein the deposited amorphous solid layer has a thickness of 2 microns or less.

4. The method of claim 1 wherein said molecules or atoms of the vapor comprise one or more of cyclohexanol, methanol, ethanol, isopentane, water, O₂, Si, SiO₂, S, C, Ge, Fe, Co, and Bi.

5. The method of claim 1 wherein said molecules or atoms of the vapor are water molecules and the amorphous solid layer is an amorphous ice layer.

6. The method of claim 1 wherein the analyte particles and vapor in step a) are cooled to a temperature of −130° C. or less.

7. The method of claim 1 wherein the analyte particles and vapor in step a) are cooled to a temperature of −175° C. or less.

8. The method of claim 1 wherein the substrate surface is a transmission electron microscopy (TEM) grid.

9. The method of claim 1 wherein the analyte particles are ions generated from a mass spectrometer device using electrospray ionization or laser desorption.

10. The method of claim 1 wherein the substrate surface in step c) is at a temperature of −130° C. or less.

11. The method of claim 1 wherein the substrate surface in step c) is at a temperature of −175° C. or less.

12. The method of claim 1 wherein the step of contacting the substrate surface with the trapped analyte particles is carried out at a pressure equal to or less than 10⁻⁴ Torr.

13. The method of claim 1 further comprising adjusting the thickness of the amorphous solid layer around each of said analyte particles by adjusting the concentration of the atoms or molecules in the vapor.

14. The method of claim 1 further comprising adjusting the thickness of the amorphous solid layer around each of said analyte particles by adjusting the mixing time between the analyte particles and vapor in the cooling chamber.

15. The method of claim 1 further comprising determining the amount of atoms or molecules deposited on said analyte particles to form the amorphous solid layer.

16. The method of claim 15 wherein the amount of atoms or molecules is determined by a mass analyzer.

17. A method for preparing a sample for cryo-electron microscopy (cryo-EM) comprising the steps of:
a) generating a controllable ion beam containing charged analyte ions using a modified mass spectrometer, and directing the ion beam to a substrate surface;
b) mixing a vapor comprising atoms or molecules with at least a portion of the analyte ions in the analyte beam in a cooling chamber at a temperature of −90° C. or less;
c) forming an amorphous solid layer of the atoms or molecules from the vapor around the analyte ions, thereby forming trapped analyte ions;
d) contacting the substrate surface with the analyte ions while under vacuum at a temperature of −90° C. or less,
thereby forming a layer of analyte ions on the substrate surface.

18. The method of claim 17 wherein the analyte ions are generated using electrospray ionization.

19. The method of claim 17 further comprising transferring the substrate surface containing the layer of analyte ions to a microscope portion of a cryo-electron microscope.

20. The method of claim 17 wherein the substrate surface is contacted with at least a portion of the analyte ions and the vapor concurrently.

21. The method of claim 17 wherein the substrate surface is contacted with the analyte ions prior to being contacted with the vapor.

22. The method of claim 17 wherein the analyte ions and vapor in step b) are cooled to a temperature of −175° C. or less.

23. The method of claim 17 wherein the substrate surface in step c) is at a temperature of −175° C. or less.

24. A method for preparing a sample for cryo-electron microscopy (cryo-EM) comprising the steps of:
a) generating and cooling charged or uncharged analyte particles to a temperature of −90° C. or less;
b) contacting a substrate surface with the cooled analyte particles, wherein the substrate surface is at a temperature of −90° C. or less, thereby forming a layer of analyte particles on the substrate surface;
c) forming a vapor stream of atoms or molecules; and
d) contacting the substrate surface with the vapor stream while under vacuum at a temperature of −90° C. or less,
thereby forming an amorphous solid layer on the substrate surface, wherein the analyte particles are embedded on or within the amorphous solid layer, and wherein the deposited amorphous solid layer has a thickness of 2 microns or less.

25. The method of claim 24 wherein the substrate surface is contacted with the cooled analyte particles and vapor stream concurrently.

26. The method of claim 24 wherein the substrate surface is contacted with the cooled analyte particles prior to being contacted with the vapor stream.

27. The method of claim 24 wherein the vapor stream comprises molecules or atoms able to form amorphous solids, said molecules or atoms comprising one or more of cyclohexanol, methanol, ethanol, isopentane, water, O₂, Si, SiO₂, S, C, Ge, Fe, Co, and Bi.

28. The method of claim 24 wherein the vapor stream comprises a molecular water molecule beam and the amorphous solid layer is an amorphous ice layer.

29. The method of claim 24 wherein the analyte particles in step a) are cooled to a temperature of −130° C. or less.

30. The method of claim 24 wherein the analyte particles in step a) are cooled to a temperature of −175° C. or less.

31. The method of claim 24 wherein the substrate surface is a transmission electron microscopy (TEM) grid.

32. The method of claim 24 wherein the analyte particles are ions generated from a mass spectrometer device using electrospray ionization or laser desorption.

33. The method of claim 24 wherein the substrate surface in step b) is at a temperature of −130° C. or less.

34. The method of claim 24 wherein the substrate surface in step b) is at a temperature of −175° C. or less.

35. The method of claim 24 wherein the step of contacting the substrate surface with the vapor stream is carried out at a pressure equal to or less than 10⁻⁴ Torr.

36. The method of claim 24 wherein the substrate surface is contacted with the vapor stream at a temperature of −130° C. or less.

37. The method of claim 24 wherein the substrate surface is contacted with the vapor stream at a temperature of −175° C. or less.
